(19) United States
(12) Patent Application Publication
(10) Pub. No.: US 2014/0372430 A1
(43) Pub. Date: Dec. 18, 2014

(54) AUTOMATIC AUDIENCE DETECTION FOR MODIFYING USER PROFILES AND MAKING GROUP RECOMMENDATIONS

(71) Applicant: Microsoft Corporation, Redmond, WA (US)

(72) Inventors: Mikael Sitruk, Yokneam (IL); Noam Koenigstein, Ra'anana (IL); Royi Ronen, Tel Aviv (IL); Elad Ziklik, Modi'in (IL)

(73) Assignee: Microsoft Corporation, Redmond, WA (US)

(21) Appl. No.: 13/918,899

(22) Filed: Jun. 14, 2013

(51) Int. Cl. G06F 17/30

(52) U.S. Cl. CPC G06F 17/30312
USPC 707/736

(57) ABSTRACT

Disclosed herein is a system and method for determining that a current user profile in a system should be modified or changed. An audience detection component detects that a characteristic has been detected that does not match at least one characteristic in the current user profile. The audience detection component determines how the profile should be modified or restricted based on the inputs received from the sensors. The modified profile is then provided to a recommender system so that appropriate content may be suggested to the consumers without any further intervention or action required by the user.

### TECHNICAL FIELD

This description relates generally to detecting a group or other individual not part of the user profile is using a content providing system and modifying the profile accordingly such that a recommendation system may make recommendations are more personalized to the group.

### BACKGROUND

Marketplaces have historically provided users with a list of recommended items that the user may be interested in. However, these recommendations have historically been based off of the relationships between items. Typically this has been in the form of “people who have bought this have also bought these items”. More advanced systems of recommendations look at the items themselves to determine if the items are related and the user may be interested in the items based on a similarity between the item being looked at and these items. However, these recommendations are rarely based on the actual environment in which the user is currently in. Further, these recommendations will often provide content suggestions that are not appropriate for the situation such as single player games when the user is hosting a party and has a large number of people present. The user is often forced to manually cause filters to be applied to find content that is appropriate, such as limiting results to only multi-player games.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method determining that a current user profile in a system should be modified or changed. An audience detection component detects via sensors that a characteristic has been detected that does not match at least one characteristic in the current user profile. This difference can occur because more than one person has been detected indicating that a group is present or that a different individual is attempting to user the current user profile. The audience detection component determines how the profile should be modified or restricted based on the inputs received from the sensors. In some embodiments a new profile is created for a group. The profile is then provided to a recommender system so that appropriate content may be suggested to the consumers without any further intervention or action required by the user.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of a group recommendation and profile modification system 100 for determining that a profile needs to be modified based on detected events according to one illustrative embodiment.

FIG. 2 is a block diagram illustrating an example recommender system according to one illustrative embodiment.

FIG. 3 is a flow diagram illustrating the group detection and profile modification process according to one illustrative embodiment.

FIG. 4 is a block diagram illustrating a computing device which can implement the recommendation and profile modification system according to one embodiment.

Like reference numerals are used to designate like parts in the accompanying drawings.

### DETAILED DESCRIPTION

People typically consume content such as movies and video games on their computing devices. These consumers often buy or obtain content from a marketplace of providers. These marketplaces often make recommendations to consumers about content that the provider has determined may be of interest to this consumer. This is typically done by presenting to the user of a list of recommended items that others who are looking at the current content have also been interested in. In some more advances systems a profile for the consumer may also be used to provide better recommendations to the user. One such system that makes use of the consumer's personalized profile is discussed in co-pending U.S. patent application Ser. No. ______ filed ______, entitled INCORPORATING USER USAGE OF CONSUMABLE CONTENT INTO RECOMMENDATIONS the contents of which are incorporated by reference herein in their entirety. Further, the consumer may have a large amount of consumable content already stored or otherwise available to them that they may have also forgotten about.

The use of a consumer profile for making a recommendation to the consumer works quite well when that consumer is the one selecting the content they wish to consume. Individual based recommendation systems do not work as well in recommending content when the content that the consumer desires is outside what the consumer normally would want. This can occur when for example a family or other group wishes to watch a movie together. The information in the individual's personal profile would only provide recommendations that are personal for that user, some of which are likely inappropriate for a group situation. As a family may have different desires in what they wish to consume than an individual family member. Further, in many homes only one profile may be present on the system even though there are multiple users of the system. Typically this occurs when children use their parents' account to access content. Their user of the profile can cause two things to occur. First the parents personal preferences may be shown to the children and that content may be inappropriate for children. Second, the children's preferences can influence the recommendations that are presented to the parents at a later time. (e.g. Parents do not necessarily wish to watch Dora the Explorer on a date night).

The present disclosure provides a system and method for modifying a profile on a computing system in response to the system detecting that at least a set of characteristics associated with the profile currently in use differs from what is currently detected by the system. Using more advanced sensors the present system can determine if a group is present and adjust the current profile to a group profile by having either a new profile created for a group or simply modifying the current profile to a group profile. By changing the current profile to a group profile recommendations made by a marketplace or a recommender system will be more tailored for the group. This approach also allows the preservation of the individual profile preferences so that individual recommendations are not necessarily impacted by the group preferences.

Further, through the use of the sensors the present system is able to determine if a different individual is using the currently active profile. When a discrepancy is determined between the detected person and the active profile the system can try to find the correct profile for the detected individual, or can apply predetermined rules to the active profile. This approach allows for the preservation of the individual profile as well as for parents to limit access to content that may be accessible through their accounts without having to worry about having left the account open.

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

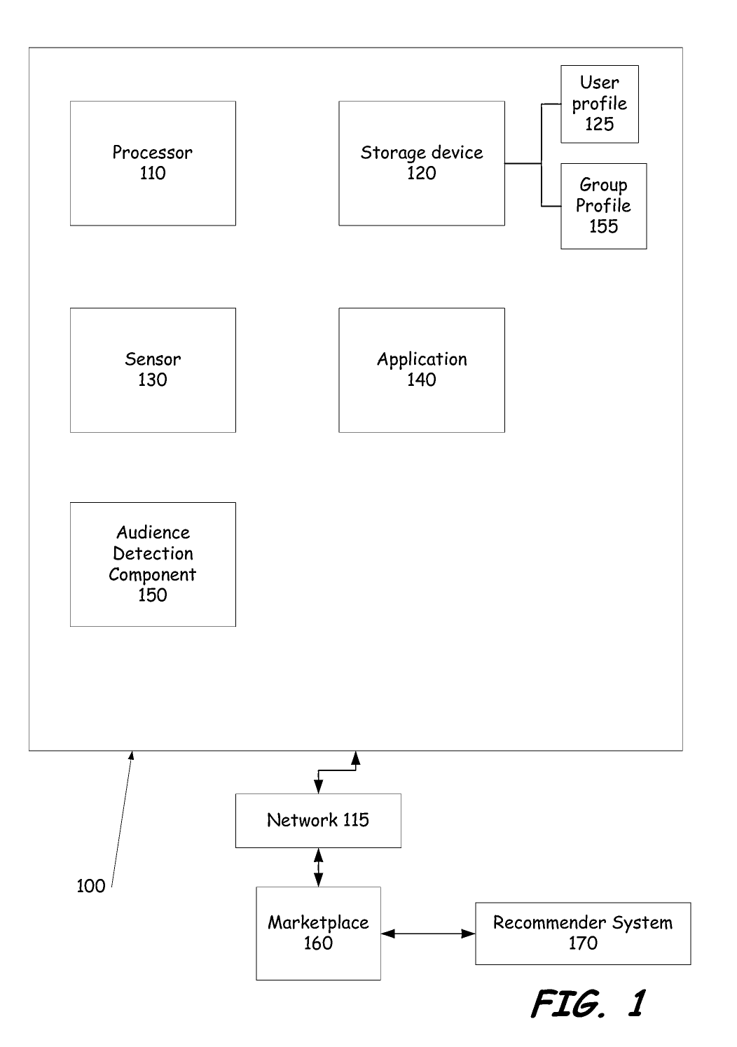

FIG. 1 is a block diagram of a system 100 incorporating the user profile modification, and group recommendation and detection system 100 according to one illustrative embodiment. System 100 includes a processor 110, a storage device 120, a display, at least one sensor 130, and at least one application 140 and an audience detection component 150. System 100 is in one embodiment connected via a network 115 to a marketplace 160 that provides content to the system 100 and includes a recommender system 170 that provides recommendations to the marketplace 160 and thus to the users of the system 100. In some embodiments the marketplace 160 and recommender system 170 are present on system 100 as well.

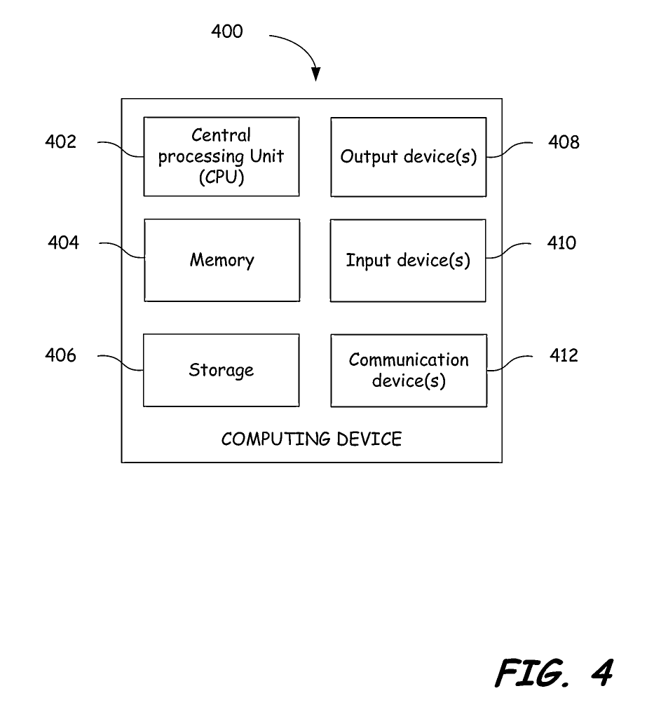

System 100 can in one embodiment be a computing device such as the computing device discussed below with respect to FIG. 4. In other embodiments system 100 can be a gaming console such as and Xbox™ or PlayStation™, can be a cable or satellite television receiver/tuner, or any other device that provides content to a user and provides recommendations to the user through the marketplace 160 of content the user may wish to consume.

Sensor 130 is a component capable of detecting the presence of a user in the vicinity of the system 100. In one embodiment sensor 130 is a Kinect sensor 130 that uses cameras to detect the presence of an individual near the system 100. In other embodiments, sensor 130 can be a Wi-Fi sensor that detects the presence of other devices associated with the individual and can determine the proximity of the device to the system 100. Any other device that is capable of detecting the presence of an individual may be used as sensor 130, e.g. cameras, infrared sensors/cameras, pressure plates, cellular repeaters, etc. In some embodiments the sensor 130 comprises a plurality of sensors that work in conjunction with each other to detect individuals in proximity to the system 100.

Application 140 is in one embodiment a movie application 140 where the user is capable of downloading or viewing motion picture content on the device through the display, such as Netflix™, YouTube™, Hulu™, Xbox Live™, etc. However, application 140 can be any application 140 that provides content to the user and where the user can obtain additional content, such as Pandora™, I-Heart Radio™, etc. The user typically selects the movie from the displayed options in marketplace 160 on the display and then proceeds to consume that content. This content may be downloaded to the system 100 or may be streamed from the marketplace 160 via the network 115. The user may receive from the marketplace 160 a number of recommendations prior to selecting the particular movie they wish to view. In some embodiments, system 100 may have multiple applications 140 some of which may connect to a marketplace 160 and some of which may be standalone applications 140 that do not connect to a marketplace 160. In some embodiments the list of applications 140 that are presented to the user may be filtered or limited based upon the user's profile and information provided by the sensor 130.

Storage device 120 is in one embodiment a storage device 120 configured to store both the content that is to be displayed on the application 140 when the content is not provided in a streaming manner from the marketplace 160, the application 140, and a user profile 125. The user profile 125 is a profile for the user that includes information about that particular user. User profiles 125 are typically associated with an individual and most system 100s treat a single user profile 125 as a profile for an individual. The user profile 125 typically includes things about the user such as age, gender, location, system 100 settings, icons, avatars, etc. Further the user profile 125 may include information (data) related to the user's preferences with respect to content, such as the user likes action movies, likes comedy movies, but doesn't like dramatic movies. The profile may also include information that permits the user to access the marketplace 160 and make purchases from the marketplace 160. Additionally, the user profile 125 may be shared across multiple devices such as when the user has a profile on a commercial site such as Facebook™ or Xbox Live™. In these instances the profile may be synced with a profile providing service so that the user's profile on the system 100 is synchronized with the user's profile on the commercial service. In other embodiments the user profile 125 may be created on the system 100 by merging multiple online profiles together. In yet other embodiments, the user profile 125 may include additional controls, such as parental controls to prevent inadvertent access to content by an unauthorized person (e.g. a child) that is inappropriate or restricted. In some embodiments storage device 120 holds multiple user profiles 125 such as when there are multiple users of the system 100 in a single location. In this embodiment the individual would need to select the correct profile prior to accessing the content on the system 100 to have their profile associated with the content. In some embodiments storage device 120 also stores content that user has downloaded or otherwise saved. This content can later be retrieved and consumed by the user. In some embodiments the storage device 120 is a cloud storage device, whereby the profiles and content are stored at a location that is accessible to the user through the network. In other embodiments, the storage device 120 includes both local and cloud storage.

Audience detection component 150 is a component of the system 100 that is able to detect and determine the individuals that are currently in the proximity of the system 100. Audience detection component 150 receives data from the sensor 130 and processes that data to determine the number of individuals that are in proximity to the system 100. In some embodiments the audience detection component 150 is capable of determining the physical location of an individual in the proximity of the system 100. The audience detection component 150 also receives data related to the application 140 that is currently active on the system 100 and the currently active user profile 125. The audience detection component 150 may also receive data from the application 140 indicating what the application 140 is currently displaying to the user. This information is then used by the audience detection component 150 to determine if an adjustment to the overall system 100 is needed. This adjustment to the overall system 100 can include applying parental controls if the user profile 125 information does not match or correspond to the information received from the sensor 130, e.g. the detected user is smaller than the user associated with the user profile 125 indicating that a child is interacting with an adults account. Another example is that the sensor 130 has detected multiple people in proximity to the system 100 and the application 140 is currently communicating with the marketplace 160 to select content. In this example the audience detection component 150 can modify the user profile 125 that is communicated to the market place from an individual profile to a group profile 155. Any method for building a profile for a user may be used by the system in building the user profile. In another example the audience detection component 150 can use the physical location of the individual to provide a filtered list of applications 140 for the user to select from. This filtered list can be provided when the user profile 125 indicates that the current user typically only performs certain activities or views certain applications 140 when they are in the detected location. E.g. the user only watches movies or uses a video chat application 140 when they are sitting on the couch.

The group profile 155 is in one embodiment a profile that is stored on the storage device 120 as a separate profile. This profile may include information that is tuned for a group as opposed to an individual. For example the group profile 155 may include information that favors movies or games that are typically played or consumed by groups as opposed to individuals, such as raunchy movies, or multiplayer games, or games that require two or more people to play, etc. In other embodiments the audience detection component 150 may create a group profile 155 on the fly for the users. It may use information gathered from the sensor 130 to determine the relative make-up of the group. For example, using size data received from the sensor 130 the audience detection component 150 could determine that the make-up of the group is small children and then create a profile or modify the profile to favor content suitable for young children, despite the fact that the currently active profile is an adult's profile. In other embodiments the group profile 155 can be created by obtaining the profiles for each of the detected individuals from devices carried by these individuals.

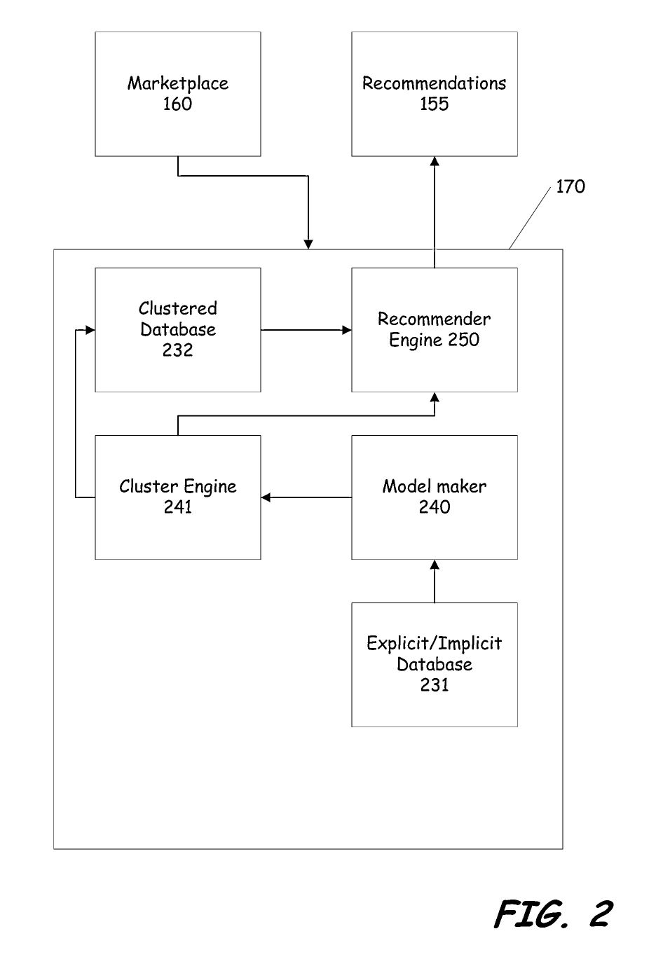

The marketplace 160 is in one embodiment a consumer marketplace 160 accessed by consumers to purchase or obtain content and have that content delivered to them via network 115. The marketplace 160 permits the user to search for content and also provides recommendations to the user about content they may be interested in by communicating with a recommender system 170. An example recommender system 170 is discussed with respect to FIG. 2 below. The marketplace 160 receives the user profile 125 (or group profile 155) from the system 100. The profile is used by the marketplace 160 to process any transactions and to make recommendations to the user. In some embodiments the marketplace 160 may update the user's profile based on actions taken by the user in selecting content. In some embodiments the system 100 may include local versions of a marketplace 160 and recommender system 170. This can allow for the user to receive recommendations about content they already have stored on storage device 120 that may be appropriate or they may simply have forgotten about.

FIG. 2 schematically shows a recommender system 170 operating to provide recommendations to users such as user associated with user profile 125 or group profile 155 in FIG. 1 above, that may access the recommender system through the marketplace 160 using the system 100 according to one illustrative embodiment. However, any available recommender system may be used. Recommender system 170 in some embodiments comprises an “explicit-implicit database” 231 comprising explicit and/or implicit data acquired responsive to preferences exhibited by a population of users for items in a catalog of items. Recommender system 170 may comprise a model maker 240 and a cluster engine 241 that cooperate to cluster related catalog items in catalog clusters and generate a clustered database 232. A recommender engine 250 recommends catalog items from catalog clusters in clustered database 232.

Explicit data optionally comprised in explicit-implicit database 231 includes information acquired by recommender system 170 responsive to explicit requests for information submitted to users in the population. These requests can be obtained in one embodiment from the user when the user generates their personal profile with the marketplace or first interacts with the system 100. Explicit requests for information may comprise, for example, questions in a questionnaire, requests to rank a book or movie for its entertainment value, requests to express an opinion on quality of a product, or requests to provide information related to likes and dislikes. Implicit data in the explicit-implicit database 231 can includes data acquired by the recommender system 170 responsive to observations of behavior of users in the population that is not consciously generated by an explicit request for information. For example, implicit data may comprise data responsive to determining how the user uses content displayed by the system 100.

Model maker 240 processes explicit and/or implicit data comprised in explicit-implicit database 231 to implement a model for representing catalog items that represents each of the catalog items by a representation usable to cluster the catalog items. Cluster engine 241 processes the representations of the catalog items provided by model maker 240 to generate “clustered database” 232 in which the plurality of catalog items is clustered into catalog clusters, each of which groups a different set of related catalog items. While FIG. 2 schematically shows explicit-implicit database 231 as separate from clustered database 232, clustered database 232 may be comprised in explicit-implicit database 231. To generate clustered database 232, cluster engine 241 may for example simply mark records in explicit-implicit database 231 to indicate clusters with which the records are associated.

Any of various models for providing representations of catalog items and methods of processing the representations to cluster the catalog items and generate clustered database 232 may be used in practice of an embodiment of the invention. Model maker 240 may for example generate representations of catalog items that are based on feature vectors. Optionally, model maker 240 represents catalog items by vectors in a space spanned by eigenvectors, which are determined from a singular value decomposition (SVD) of a “ranking matrix” representing preferences of users for the catalog items. Model maker 240 may represent catalog items by trait vectors in a latent space determined by matrix factorization of a ranking matrix. However, other methods may be employed.

Cluster engine 241 optionally clusters catalog items in a same catalog cluster if same users exhibit similar preferences for the catalog items. Optionally, cluster engine 241 uses a classifier, such as a support vector machine, trained on a subset of the catalog items to distinguish catalog items and cluster catalog items into catalog clusters. In an embodiment of the invention, cluster engine 241 uses an iterative k-means clustering algorithm to cluster vectors representing catalog items and generate clustered database 232.

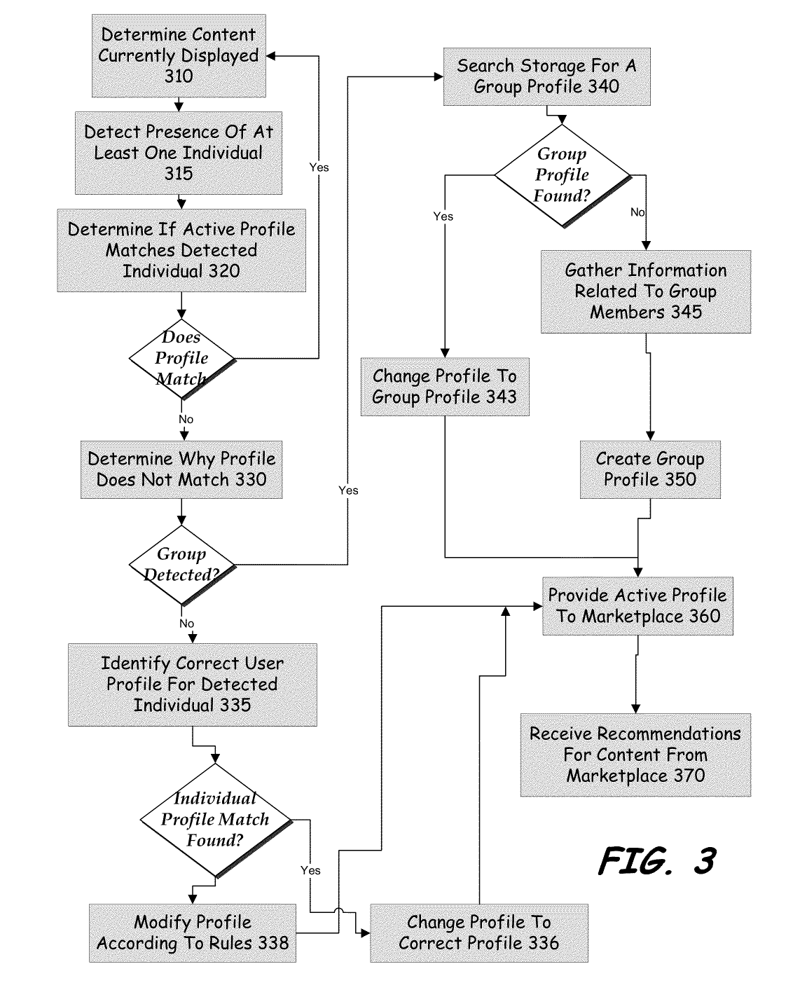

FIG. 3 is a flow diagram illustrating a process used by the audience detection component 150 to determine or modify a profile that is provided to a recommender system 170 according to one illustrative embodiment. The process begins by having the audience detection component 150 determining the content that is currently active on the system 100. This content may be, for example, a game that is being played, a movie being played, an interaction with the marketplace 160, accessing applications 140 that are stored on the system 100, etc. Additionally, characteristics of the content can also be determined at this stage. This is illustrated at step 310. The audience detection component 150 also receives information from the sensor 130 indicating that the sensor 130 has detected at least one individual within the proximity of the system 100. This monitoring is illustrated at step 315. In some embodiments the process may begin at step 315.

At step 320 the audience detection component 150 determines the currently active user profile 125 for the system 100 and determines if the user profile 125 corresponds with the information received from the sensor 130. The audience detection component 150 in one embodiment also considers the currently active content in the application 140 in determining whether the user profile 125 is the correct user profile 125. For example, the sensor 130 may indicate that there are multiple individuals around the system 100, but that the currently active content on the application 140 is a single player game, and that only one of the individuals detected is engaging in the game. In this example the audience detection component 150 would determine that the user profile 125 for an individual is appropriate and therefore, no changes are needed to the profile. Alternatively, if the system 100 detects a number of individuals in proximity to the system 100 and that the active content is a search of the marketplace 160 the audience detection component 150 can determine that a single user profile 125 not appropriate. If the profile is appropriate the audience detection component 150 returns to the monitoring step. If the profile is determined not to match the detected individual(s) the process continues to step 330.

At step 330 the audience detection component 150 determines a reason that the user profile 125 was not appropriate. As discussed earlier the user profile 125 may not be appropriate because multiple people were detected by the sensor 130, or that the individuals that were detected did not correspond to information about the user in the user profile 125. For example, the audience detection component 150 detected a small person and the profile was for an adult, or that there are multiple adults present. If the audience detection component 150 determined that the detected individual was not the correct individual the process advances to step 335.

At step 335 the audience detection component 150 determines if there is another user profile 125 in the system 100 that corresponds to the detected individual. This can be done by searching the stored user profiles 125 in the storage device 120 to find a user profile 125 that matches the characteristics of the detected individual. If a user profile 125 that matches the detected characteristics of the individual the audience detection component 150 can switch the user profile 125 from the current profile to the identified user profile 125. This is illustrated at step 336.

If a corresponding user profile 125 cannot be found for the detected individual the audience detection component 150 can apply logic rules to determine if any changes need to be made to the currently active user profile 125. For example, if the audience detection component 150 detected a child, the audience detection component 150 can look to the user profile 125 and see if there are parental control information in the profile or stored elsewhere on the system 100. If there are the audience detection component 150 can cause the parental controls to be implemented. Further, the audience detection component 150 can create a profile, either on a permanent or temporary basis, that is appropriate for a child. This profile can simply be a temporary modification of the current profile. The modification of the profile is illustrated at step 338.

If the audience detection component 150 determined that the reason for the profile not being appropriate was because multiple individuals were detected by the sensor 130 the process continues to step 340. At this step the audience detection component 150 searches the storage device 120 for a user profile 125 that is appropriate for a group of people. If this profile is found then the user profile 125 is switched to the group profile 155 that was identified. This is illustrated at step 343.

If there was no group profile 155 found in the storage device 120, the audience detection component 150 starts the process of either modifying the current user profile 125 or creating a new profile appropriate for a group. The audience detection component 150 gathers from the sensor 130 any information that it can regarding the detected members. This is illustrated at step 345.

This information can include the detected number of individuals, the individual's detected sizes, their relative location to the system 100, or other physical information about the detected individuals. Based on this information and other information available to the audience detection component 150, such as information that compares the size of individuals to sex and/or age, the audience detection component 150 builds a profile for the group including this information. Again, any approach for generating a profile from the received information or data may be used. This profile is then made the active profile for the system 100.

In an alternative embodiment, the sensor 130 can determine that a number of individuals detected have a device with them that allows for a more detailed profile generation. In this embodiment the audience detection component 150 sends a signal to each of the devices that are detected by the sensor 130 and requests any profile information that the device makes available to the system 100. Each device then responds with the appropriate profile information which is received by the audience detection component 150. The audience detection component 150 then creates a group profile 155 for this group of people by processing the received profile information for each person and merging or combining the profile information to create a single user profile 125 for the group.

In some embodiments the information can include the determination that some individuals detected should be exclude from the group while considering other individuals. For example, the audience detection component 150 can determine that an adult is simply sitting on the couch watching the child who is playing a game but that the group should only include the detected child. In this embodiment the profile that is generated is a profile for the child and not an adult and child. This embodiment can be used in other situations where only some of the detected persons should be considered part of the group. The building of the group profile 155 is illustrated at step 350.

At step 360 the marketplace 160 is accessed by one of the users. The audience detection component 150 transmits to the marketplace 160 the user profile 125 that was determined by the audience detection component 150 to be the appropriate profile for the detected individuals.

The marketplace 160 processes the user profile 125 that is received through the recommender system 170 and returns to the system 100 a set of recommendations for consumable content that is based on the profile that was provided by the audience detection component 150 to the marketplace 160. This is illustrated at step 370.

FIG. 4 illustrates a component diagram of a computing device according to one embodiment. The computing device 400 can be utilized to implement one or more computing devices, computer processes, or software modules described herein. In one example, the computing device 400 can be utilized to process calculations, execute instructions, receive and transmit digital signals. In another example, the computing device 400 can be utilized to process calculations, execute instructions, receive and transmit digital signals, receive and transmit search queries, and hypertext, compile computer code, as required by the system of the present embodiments. Further, computing device 400 can be a distributed computing device where components of computing device 400 are located on different computing devices that are connected to each other through network or other forms of connections. Additionally, computing device 400 can be a cloud based computing device.

The computing device 400 can be any general or special purpose computer now known or to become known capable of performing the steps and/or performing the functions described herein, either in software, hardware, firmware, or a combination thereof.

In its most basic configuration, computing device 400 typically includes at least one central processing unit (CPU) 402 and memory 404. Depending on the exact configuration and type of computing device, memory 404 may be volatile (such as RAM), non-volatile (such as ROM, flash memory, etc.) or some combination of the two. Additionally, computing device 400 may also have additional features/functionality. For example, computing device 400 may include multiple CPU's. The described methods may be executed in any manner by any processing unit in computing device 400. For example, the described process may be executed by both multiple CPU's in parallel.

Computing device 400 may also include additional storage (removable and/or non-removable) including, but not limited to, magnetic or optical disks or tape. Such additional storage is illustrated in FIG. 5 by storage 406. Computer storage media includes volatile and nonvolatile, removable and non-removable media implemented in any method or technology for storage of information such as computer readable instructions, data structures, program modules or other data. Memory 404 and storage 406 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 400. Any such computer storage media may be part of computing device 400.

Computing device 400 may also contain communications device(s) 412 that allow the device to communicate with other devices. Communications device(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 400 may also have input device(s) 410 such as keyboard, mouse, pen, voice input device, touch input device, etc. Output device(s) 408 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A system comprising
at least one processor;
at least one storage device;
at least one sensor, the at least one sensor configured to detect the presence of at least one individual;
at least one application configured to provide consumable content to the at least one individual; and
an audience detection component configured to receive a signal from the at least one sensor and to determine at least one characteristic of the detected at least one individual, and to select a current user profile based on the at least one characteristic.

2. The system of claim 1 wherein the at least one individual comprises a plurality of individuals; and wherein the audience detection component is further configured to:
determine if the current user profile is associated with an individual; and
change the current user profile to a group profile when the current user profile is associated with the individual.

3. The system of claim 2 wherein the audience detection component is further configured to:
modify the current user profile to indicate that it is the group profile.

4. The system of claim 2 wherein the audience detection component is further configured to:
generate the group profile when a plurality of individuals are detected by the at least one sensor.

5. The system of claim 4 wherein the at least one sensor is configured to detect at least one device associated with at least one of the plurality of individuals; and
wherein the audience detection component is further configured to:
request profile information for a user of the at least one device; and
generate the group profile by incorporating at least a portion of the profile information from the device into the generated group profile.

6. The system of claim 1 wherein the audience detection component is further configured to:
determine that the at least one characteristic is inconsistent with a corresponding characteristic of the current user profile; and
modify the current user profile based on the inconsistency.

7. The system of claim 6 wherein the audience detection component is configure to modify the current user profile by applying parental controls to the current user profile

8. The system of claim 6 wherein the audience detection component is configured to modify the current user profile by selecting a different user profile from a set of user profiles stored on the storage device.

9. The system of claim 1 wherein the at least one application comprises a plurality of applications and the audience detection component is further configured to filter a list of application presented to the user based upon the current user profile and information detected by the sensor.

10. A method for modifying a user profile associated with an application providing consumable content on a computing device, comprising:
receiving a signal from at least one sensor, the signal indicating the presence of at least on individual in proximity to the sensor;
determining a currently active user profile;
determining if characteristics of the detected individual match characteristics of the currently active user profile;
modifying the currently active user profile when the determined characteristics do not match the characteristics of the currently active user profile;
providing the currently active user profile to a marketplace; and
receiving recommendations from the marketplace, the recommendations for consumable content corresponding to the currently active user profile.

11. The method of claim 10 wherein modifying the currently active user profile further comprises:
searching a storage device for a stored user profile that matches the determined characteristics; and
changing the currently active user profile to the stored user profile when the characteristics of the stored user profile match the determined characteristics.

12. The method of claim 10 wherein the received signal indicates the presence of a plurality of individuals.

13. The method of claim 12 wherein modifying the currently active user profile further comprises;
determining that the currently active user profile is associated with an individual; and
changing the currently active profile to a group profile when the currently active profile is associates with the individual.

14. The method of claim 13 wherein changing the currently active profile to the group profile further comprises:
searching a storage device for a stored group profile; and
using the stored group profile as the group profile.

15. The method of claim 13 wherein changing the currently active group profile to the group profile further comprises:
generating a new group profile by modifying the currently active profile by adding characteristics to the profile indicative of a group.

16. The method of claim 15 further comprising:
wherein the sensor detects at least one device associated with one of the plurality of individuals;
obtaining from the at least one device a profile associated with a user of that device; and
combining the currently active user with the obtained profile to generate the new group profile.

17. The method of claim 10 further comprising:
determining that the detected at least one individual is a child;
determining that the currently active user profile is associated with an adult; and
modifying the currently active user profile to indicate that the profile is associated with a child.

18. The method of claim 17 wherein modifying the currently active user profile further comprises:
applying access controls to content provided by the application.

19. The method of claim 10 further comprising:
determining at least one characteristic of the content currently being provided by the application.

20. A computer readable storage medium having computer readable instructions that when executed cause a computer to:
receive a plurality of signals for a plurality of sensors, the plurality of signals indicating that a plurality of individuals have been detected in proximity to a system providing consumable content to users;
determine that a current user profile is an individual profile;
detect user profiles associated with a plurality of devices associated with the plurality of individuals;
obtain the user profiles from the plurality of devices;
combine the obtained user profiles with the current user profile to create a group user profile;
provide the group profile to a marketplace containing consumable content; and
receive from the marketplace recommendations of consumable content that corresponds to the provided group profile.
